(19) United States
(12) Patent Application Publication
(10) Pub. No.: US 2018/0111408 A1
(43) Pub. Date: Apr. 26, 2018

(54) ARTISTIC DRY-ERASE BOARD

(71) Applicant: Arif ROCHMAN, Santa Venera (MT)

(72) Inventor: Arif ROCHMAN, Santa Venera (MT)

(21) Appl. No.: 15/791,344

(22) Filed: Oct. 23, 2017

Related U.S. Application Data
(60) Provisional application No. 62/411,956, filed on Oct. 24, 2016.
(60) Provisional application No. 62/426,387, filed on Nov. 25, 2016.

(51) Int. Cl. B43L 1/00

(52) U.S. Cl. CPC B43L 1/00; B43L 1/008; B43L 1/004

(57) ABSTRACT

An artistic whiteboard or dry-erase board combining artwork and whiteboard. The artistic whiteboard 10 is made up of an artwork 31 attached on a foam board 32 that is mounted between a screen 41 and a frame 21 with a transparent panel 22. When not in use, the screen hangs behind the artwork so that the view of the artwork is unobstructed. When in use as a whiteboard, the screen is pulled over the artwork downwards and hangs between the artwork and transparent panel so that the artwork is obstructed.

### CROSS-REFERENCE TO RELATED APPLICATIONS

This application claims the benefit of U.S. Provisional Application No. 62/411,956 filed on Oct. 24, 2016 and U.S. Provisional Application No. 62/426,387 filed on Nov. 25, 2016.

### BACKGROUND OF THE INVENTION

Whiteboards or dry-erase boards are used for studying, teaching and presentations of information in respective locations such as private study rooms, class or lecture rooms, corporate board rooms and any type of offices. In contrast to the whiteboards in class or lecture rooms, the ones in private study rooms and offices, for instance, are not used regularly. The use of a whiteboard which is permanently mounted on the wall will diminish the aesthetic of such private study rooms and corporate rooms. Additionally, when the room is relatively small, there is no space to hang other decorative objects such as art/artist/band poster, photograph, artwork e.g. painting and 3D art object; or for corporates to display their slogan, logo, philosophy, attitude or products for branding purpose.

The primary object of this invention is therefore to provide a single artistic whiteboard that can fulfill both functions, namely as artwork display and whiteboard.

### DESCRIPTION OF PRIOR ART

There are types of whiteboards in the prior art that combine both functions, art showcase and whiteboard. U.S. Pat. No. 8,622,750, issued to Balint et al on Jan. 7, 2014, discloses a whiteboard comprising a transparent panel and screening means. The whiteboard is positioned on the wall in the front of a picture or picture frame mounted on the wall. The screening means comprises a blind windable onto a reel. In the non-use state, the blind is wound onto the reel such that the picture can be viewed through the transparent panel. In use, the blind is extended downwardly such that the blind is adjacent to and behind the transparent panel which therefore appears white and can be used as a whiteboard.

Similarly, U.S. Pat. No. 6,817,124, issued to Jung-Kuei Ko on Nov. 16, 2004, discloses an artistic black/white board with decorative function. The artistic black/white board has an artistic frame. Two reels are hidden in two opposite sides of the frame. At least one picture is extensibly wound on one of the reels. In use, the artistic black/white board serves as a normal black/white board for writing and memorizing things. When not used, the picture is pulled out and unwound from the reel to cover the black/white board to serve as a wall painting for achieving a decorative effect and

It is apparent from the foregoing that the prior art fails to have two functions in one device, namely as an artwork display and a whiteboard, or in other words it fails to combine an artwork frame/showcase/cabinet and whiteboard in one device. The first prior art covers the picture frame mounted on the wall. This means that the picture frame is not part of the whiteboard. The latter prior art is basically a whiteboard which will be covered by the downwards extended blind that has a picture to serve as a decorative effect.

### SUMMARY OF THE INVENTION

The main object of the present invention is to provide a single artistic whiteboard that can be used as a whiteboard and an artwork display when it is not in use.

The aforementioned artistic whiteboard comprises an artwork attached on a foam board that is mounted between a screen assembly and a frame with a transparent panel. When not in use, the screen hangs on the back of the artwork so that the view of the artwork is unobstructed e.g. for a decorative or advertising purpose. When in use, the screen is pulled over the artwork downwards and hangs between the artwork and transparent panel so that the artwork is obstructed to serve as a black/whiteboard.

In respect to the artwork, it refers to any wall art or wall decoration such as painting, glass artwork, collage picture frame, poster, art photograph and 3D object including wall sculpture and autographed memorabilia. The artwork may also be illuminated from the front. The printable artwork may also be in the form of a translucent surface that can be illuminated from behind in order to have a similar function as lightbox e.g. for decorative or advertising purpose. Additionally, it includes also any artwork that can be displayed alternately on electronic devices such as monitor.

Referring to the screen assembly, when not in use, the screen is preferably hung behind the artwork due to its own weight including its assembly components. This can be achieved by connecting the upper end of the screen with a support strip/rod which hangs on a round component such as a tube that can be mounted on the top of or over the artwork. A sufficiently small gap between the tube and the frame, or other assembly components, should work as stopper and hinder the screen assembly from slipping away and falling down. To pull the screen downwards, a string is connected to the both ends of the support rod and placed/hidden behind and along the frame rebate using a hook or roller mounted in the bottom corners of the main frame. To pull the screen upwards, another string is connected in the middle of another rod that is in turn mounted with the other end of the screen behind the artwork.

Still referring to the screen assembly, the screen, when not in use, may be connected to a roller mechanism mounted on one side of the artwork. The screen may be either hung or wound onto a rotating or winding tube of the roller mechanism. The screen may be rotated and respectively extended in front of the artwork by means of a commercially available crank or chain mechanism or electric motor. With regard to the alternative of wound screen, the roller mechanism may be spring loaded so that the screen can be automatically retracted by the loaded spring.

In respect to the pulling of the screen, guiding elements or guiding design features at the end of the pulling rod and/or on the artwork sides and/or on the frame sides may be provided so that the strip or screen can be pulled in parallel.

In respect to the mounting methods of this artistic whiteboard, the artwork including its holding components and the main frame are preferably mounted by means of mounting screw, pin, snap-fit or other common mechanically and magnetically detachable joints in order to ease the installation or change of the artwork. Alternatively, the main frame is designed with an opening from any of its sides so that the artwork with or without its holder frame can be slid in and out through the opening, i.e. between the transparent panel and the screen. Another alternative is to mount the fixed mounting components with the main frame, that however possess design features/components such as hinge and locking element to allow a quick mounting or (ex)change of the artwork including its assembly.

With regard to the main frame, it may be made from any kind of material such as wood, metal, plastic or even glass, that preferably can maintain or even enhance the artistic view/display of the artwork. If the frame is not made from a transparent material, it has to contain a transparent panel that works as black/whiteboard when the screen is pulled behind this transparent panel. The frame may be constructed as a single frame so that the installation or change of the artwork from the backside of this artistic whiteboard. It can alternatively consist of two frames one of which is used as a wall-mounting frame and the other one contains the transparent panel. The frame with the transparent panel may be completely separated from or hinged with the mounting frame so that it can be easily removed or opened vertically or horizontally to install or change the artwork including its holder on the mounting frame.

### BRIEF DESCRIPTION OF THE DRAWINGS

The present invention is illustrated by way of example and not limitation in the figures of the accompanying drawings, and in which:

FIG. 1 is a front view of the present invention;

FIG. 2 is a sectional view taken along line A-A of FIG. 1;

FIG. 3 is a front view showing the screen partly pulled down;

FIG. 4 is a sectional view showing the components of the frame assembly;

FIG. 5 is an exploded view of the artwork assembly;

FIG. 6 is a perspective view of the screen assembly;

FIG. 7 is a perspective view of the upper mounting bracket with a hinge;

FIG. 8 is a perspective view of the lower mounting bracket;

FIG. 9 is a perspective view showing the removal steps of the screen and artwork assemblies;

FIG. 10 is a perspective view of the lower mounting bracket with opened locking element and the front string placed around the hook;

FIG. 11 is a perspective view showing the bore in the middle of the lower part of main frame where the string is pulled through;

FIG. 12 is a perspective view of the frame-less embodiment;

FIG. 13 is an exploded view of the frame-less embodiment;

FIG. 14 is a perspective view of the top left corner from FIG. 12;

FIG. 15 is a perspective view of the bottom left corner from FIG. 12;

FIG. 16 is a sectional view of the screen-less embodiment; and

FIG. 17 is a side view of the screen-less and frame-less embodiment.

### DETAILED DESCRIPTION OF PREFERRED EMBODIMENTS

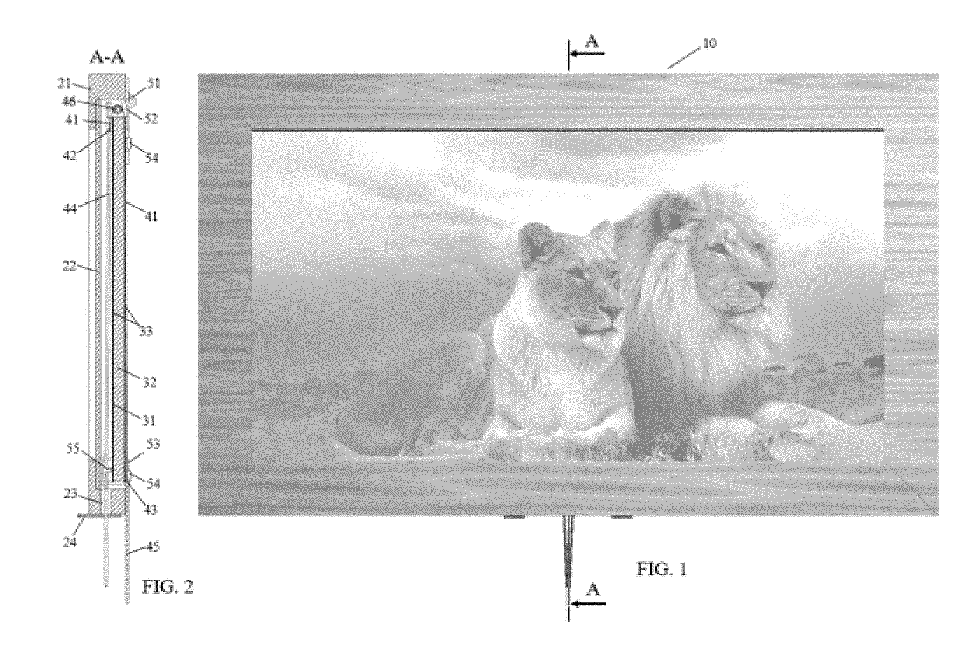

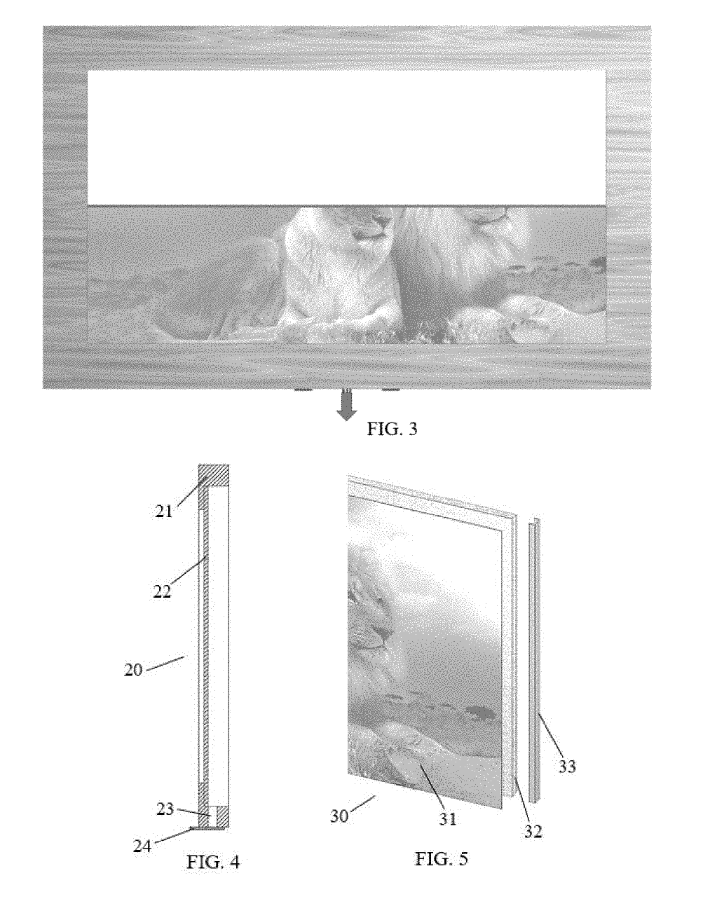

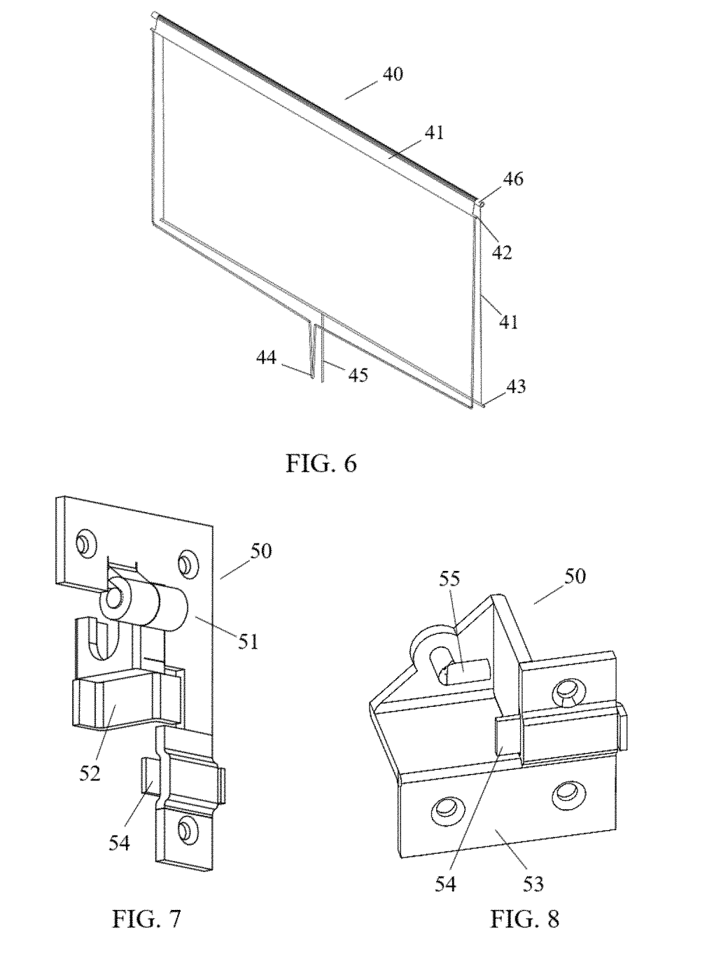

In this preferred embodiment, referring to FIGS. 1 to 11, the whiteboard 10 comprises of a frame assembly 20, an artwork assembly 30, screen assembly 40 and mounting components 50. The frame assembly 20 consists of a main frame 21 with a bore 23 in the middle of its bottom part, and a transparent panel 22. The artwork assembly contains an artwork 31 that can be directly printed or mounted on a mounting foam board 32 and supported with a metal U-shaped support frame 33. The screen assembly 40 consists of a white or color screen 41 whose both ends connected with support strips or rods 42 and 43, front pulling string 44 connected with both ends of the front support rod 42, rear pulling string 45 connected with and in the middle of the rear support rod 43, and finally a tube 46 to hang the screen.

The mounting components 50 comprise of two top brackets 51 with a hinge element 52 and two bottom brackets 53 each with a hook 55. Both top and bottom brackets have a locking element 54 to lock the whole assembly.

Still referring to FIGS. 1 to 11, when not in use, the screen 41 hangs on the tube 46 behind the artwork assembly 30 so that the view of the artwork 31 is not obstructed. In use, the screen 41 is pulled downwards over the tube 46 using the front string 44 which slides on the hook 55 of the bottom bracket 53 and through the bore 23 of the main frame 21, so that the transparent panel 22 has a white or color background to serve as a dry-erase board. The screen 41 can be brought back behind the artwork assembly 30 by pulling the rear string 45 that is connected with and in the middle of the rear support rod 43. A winding hook 24 may be mounted on the lower part of the main frame 21 to wind one of both pulling strings 44 and 45 when it is completely pulled out.

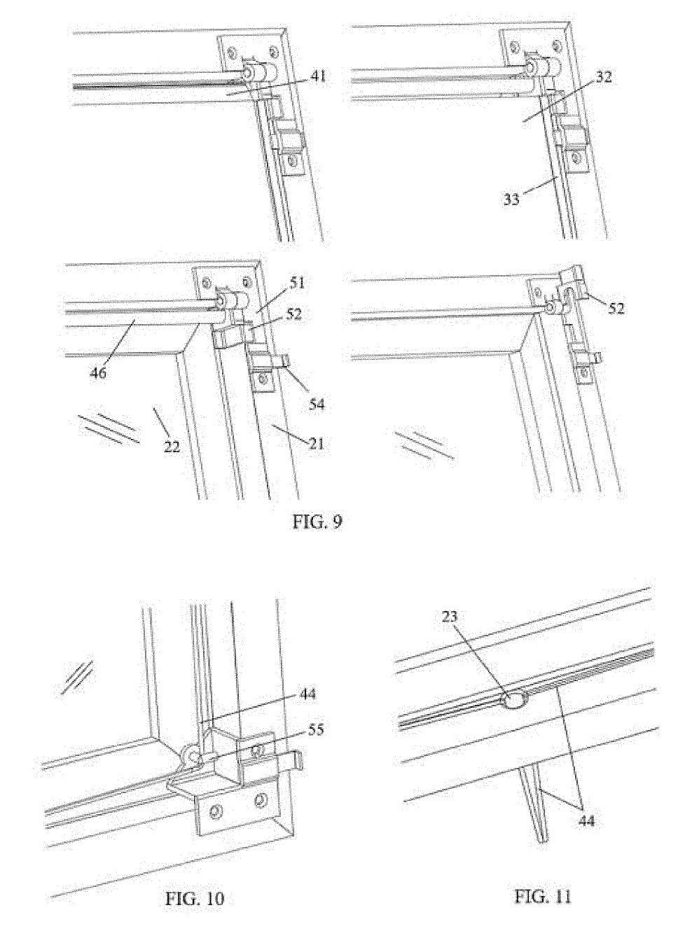

Referring particularly to FIG. 9, in this embodiment, by means of the hinge element 52 and the locking element 54, the installation or change of the artwork 31 becomes easy with the following steps: folding up the screen 41 from the back side of the whiteboard 10, unlocking/opening the locking element 54, removing the artwork assembly 30, rotating the hinge element 52 and removing the tube 46 as well as the screen assembly 40.

The main frame 21 may be made from any type of materials such as metals, plastics or woods, especially the ones that can enhance the artistic appearance of the whiteboard. Semi-finished products such as metal profiles or mouldings made from wood or plastic, that are common for picture framing, may be used to manufacture the frame 21. Dependent on the type of frame material used, any mechanical joints or adhesive can be utilized to mount or join the frame 21. Alternatively, the main frame 21 may be manufactured using molding processes such as injection molding and composite molding. In this case, the frame 21 may be manufactured as one piece so that mounting or assembly work is not anymore necessary or as several pieces and each of which possesses design features for quick mounting purposes without involving any additional mounting elements e.g. using snap filling features, or with additional simple mounting, elements such as mounting pin. Still referring to the molding process, the other components such as the brackets 51 and 53 may be designed and thus manufactured as one piece together with the main frame 21.

The transparent panel 22 is preferably made from glass due to its high rigidity and transparency and more preferably from annealed glass due to its increased toughness and most preferably from annealed glass laminated with a safety film to hold glass shards together when the glass breaks. The transparent panel 22 may be mounted using slots in the frame 21 or alternatively using additional fitting elements such as pins or tabs. The transparent panel 22 may also be loose or unfastened to the frame 21 such that it, together with the screen and artwork assemblies, will be held and locked by the brackets 51 and 53 including their hinge and locking element 52 and 54 respectively. To reduce transport cost, the whiteboard 10 may be manufactured and delivered without the transparent panel 22, especially if it is made from glass. In this case, additional fitting frame or fitting elements need to be included such that the users can purchase the transparent panel 22 from local shops and then easily mount it together with the other whiteboard's components. As an alternative to the winding hook 24, a loose winding component may be used such that after the string is wound on it, the winding component may be mechanically or magnetically attached/hanged on the lower part of the frame 21.

The artwork 31 refers to any wall art or wall decoration such as painting, glass artwork, collage picture frame, poster, art photograph and 3D object including wall sculpture and autographed memorabilia. Additionally, it includes also any artwork that can be displayed alternately on electronic devices such as monitor. For printable artwork, it may be printed directly on a sheet of material such as aluminum, glass, wood or plastic such that the mounting foam board 32 and the support frame 33 are not anymore required. If the artwork 31 is not translucent, it may be illuminated from the front, whereas translucent artwork 31 may be illuminated from behind in order to have a similar function as lightbox e.g. for decorative or advertising purpose. The artwork 31 may also be part of the screen 41 that is in the form of a roll containing several different paintings, posters, or calendar of months with one portion of it is white or in color such that the function as whiteboard or artwork can be performed alternately.

The screen 41 is preferably made from a fabric of any color especially white or bright colors, which may be coated to reduce or eliminate its porosity. The screen 41 is assembled with the support rods 42 and 43 e.g. by gluing or sewing. Both ends of the front pulling string 44 is connected to both ends of the front support rod 42 e.g. by gluing or using metal clamps. Since the rear pulling string 45 is already hidden behind the artwork assembly 30, it may only be connected in the middle of and to the rear support rod 43. The pulling strings 44 and 45 are preferably small in diameter such that they can be easily hidden behind the rebate of the main frame 21 and can also be easily wound on the hook 24 or the alternative winding component as previously described. The diameter of the tube 46 is preferably the same or slightly bigger as the thickness of the artwork assembly 30 such that the screen 41 can slide down smoothly when it is pulled. When the screen 41 is pulled down, the tube 46 may or may not rotate about its length axis. However, it is preferable when the tube 46 can easily rotate with the movement of the screen 41. This may be done through a reduction of the contact surface between the tube 46 and the hinge element 52 e.g. by mounting pin or small bearing on the tube 46 or the hinge element 52. The tube 46 may also be spring loaded and the screen 41 is rolled on the tube 46 such that the screen 41 can be retracted automatically.

The mounting components 50 are preferably made from metals such as stainless steel using common metal processing such as casting or stamping that includes punching and bending. If they are made from plastic materials as separate parts or as one piece together with the frame 21 as described above, injection molding process may be considered. The brackets 51 and 53 are preferably designed in L-shape such that they can reinforce the corners of the main frame 21. The hinge element 52 should preferably have a design feature to stop its further rotation inwards (into the main frame 21). The outwards movement of the whole assembly is locked using the locking element 54. To ease sliding of the front pulling string 44, a small roller may be used instead of the hook 55.

As an alternative to this embodiment, all components of artwork and screen assemblies including the hook or roller may be mounted together as a mounting frame assembly, whereas the main frame assembly containing the main frame and the transparent panel. Both sub-assemblies are assembled using mounting screw, pin, fitting tab, snap-fit, sliding lock, hinge, slot-fitting element, hanging element or magnet in order to ease the installation or change of the artwork. Alternatively, the mounting frame assembly is mounted on the wall, whereas the main frame assembly with the transparent panel is hung on it, or both sub-assemblies are hinged on one side so that the main frame with the transparent panel can be rotated to change the artwork. The manufacturing methods may be the same as in the previous embodiment.

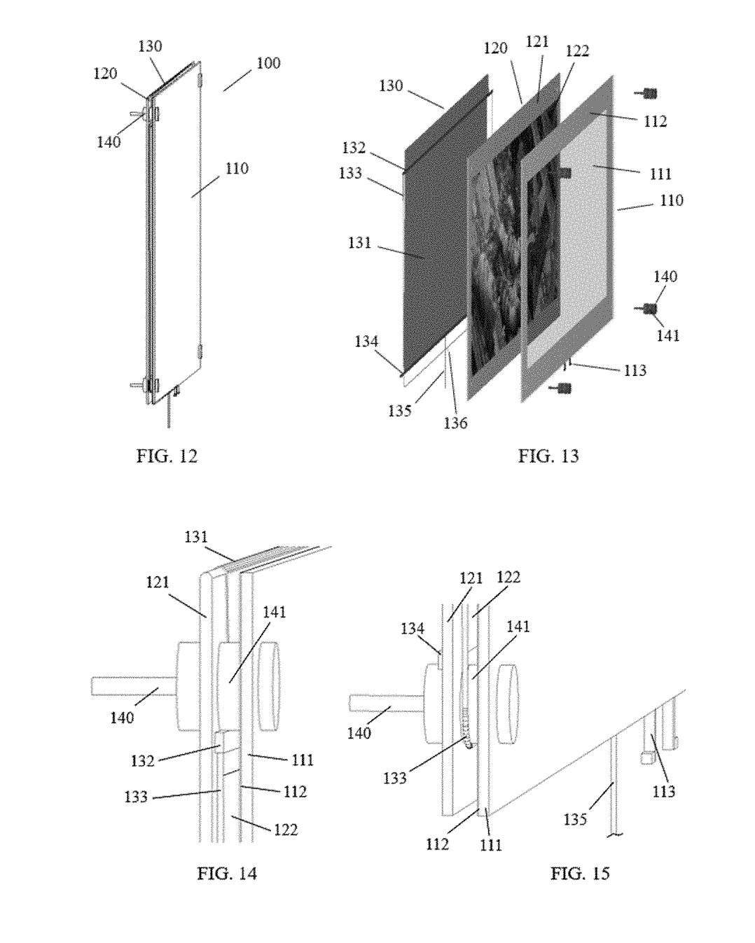

An alternative embodiment, referring to FIGS. 12 to 15, relates to a frameless artistic dry-erase board 100 that may consist of frameless transparent panel assembly 110, artwork holder frame or panel 120, screen assembly 130 and common mount hardware 140. As in previous embodiment, the screen assembly consists of a screen 131, top support strip 132, front pulling string 133, bottom support strip 134, rear pulling string 135 and puller 136 at the end of the strings. The artwork holder 120 may be in the form of a frame or panel/plate made from any material and consist of the main holder frame or panel 121 and artwork 122. The artwork 122 refers to the artwork in the previous embodiment including its all variations. The outer edges 112 of the transparent panel 111 may be painted with a non-transparent color to hide the strips and its string. Alternatively, a thin plastic film may be adhered or passepartout may be used, preferably on the back side of the transparent panel, so that the whole front surface can be used as dry-erase board. The transparent panel may have hooks 113 to wind the pulling strings. The whole assembly may be mounted to a wall using common mount hardware 140. Alternatively, only the artwork holder frame or panel is mounted on the wall, whereas the transparent panel assembly is hinged vertically or horizontally with the artwork holder frame or panel. In this case, spacers between both components are needed and can be mounted on one of them. All alternatives with regard to all sub-assemblies or components in the first embodiment also apply to this embodiment. Each mounting includes a spacer 141 to create space between the transparent panel and the artwork mounting panel. This spacer 141 is also used to slide the front pulling string 133. In this embodiment, the screen 131 slides on the rounded top of the holder frame 121. Alternatively, a tube may be rotatably mounted on the holder frame 121.

The following various embodiments may also apply to the previous two embodiments. Instead of mechanically pulling a screen between the artwork and the transparent panel, the color change may be done by changing a level of non-transparent liquid between two transparent panels, which may be pneumatically or electrically activated. Alternatively, the transparent panel may be coated or covered with a thin layer whose color can change from transparent to a non-transparent color by any means, or the material of the transparent panel itself may be modified so that the same effect can be achieved.

The screen may be in any color to make the artistic dry-erase board more attractive. The screen is preferably hanged on the back of the artwork assembly and pulled using pulling strings. Alternatively, the screen may be connected to a counterweight or elastic material or spring on the front or back side such that the screen can be retracted or extended automatically. The screen may also be connected to or wound on a reel that may be mounted on one side of the whiteboard and also spring loaded such that the screen can be automatically retracted. Additionally, the screen may be retracted and respectively extended in front of the artwork by means of a commercially available crank or chain mechanism or electric motor. A winder may also be used to wind the string and thus to retract or extend the screen instead of pulling the string downwards. Guiding elements may be included at the end of the pulling rods and/or on the main frame sides so that the pulling rod and thus the screen can be pulled in parallel.

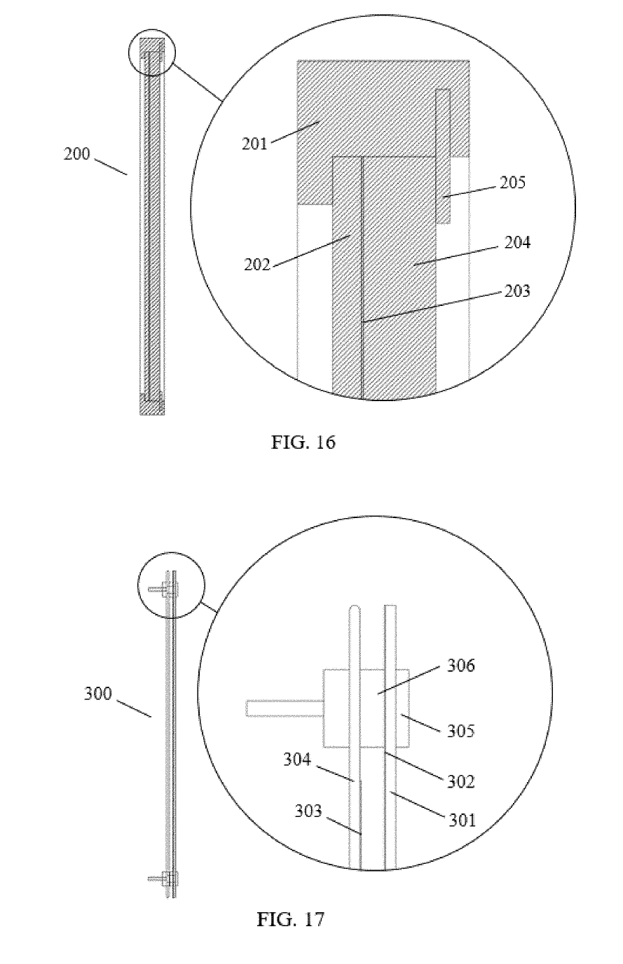

Another alternative embodiment, referring to FIG. 16, concerns a screen-less, artistic dry-erase board, wherein a smart glass or switchable glass is used instead of a screen. The screen-less dry-erase board 200 contains a frame 201, the smart glass 202, an artwork 203 mounted or directly printed on a mounting or backing board 204 and fitting elements 205. The smart glass 202 refers to a glass whose light transmission property are altered when voltage, light or heat is applied. This also includes electrically switchable smart glasses such as but not limited to electrochromic, photochromic, thermochromic, suspended particle, micro-blind and polymer dispersed liquid crystal devices, as well as non-electrical smart glasses such as but not limited to commercial products of Vistamatic®, Sunvalve® and Smartershade®. Additionally, the smart glass 202 may also refer to a standard glass with a laminated smart film which has the same function as the smart glass. The smart glass 202 may be activated by any means such as mechanical or proximity switches. The smart glass 202 refers also to its accessories to activate it such as transformer and remote control.

The material type and manufacturing of the frame 201 as well as the mounting of the artwork 203 on the mounting or backing board 204 may be the same as described in the preferred embodiment. The fitting elements 205 may refer to any magnetic or mechanical fitting elements that are commonly used in picture framing such as nails/pins or flexible tabs.

FIG. 17 shows another alternative to the previous embodiment that refers to a screen-less and frameless dry-erase board 300 containing a smart glass 301 as described in the previous embodiment, an artwork 303, an artwork mounting frame or panel 304, and common mount hardware 305 with a spacer 306 to create a gap between the smart glass 301 and the artwork 303. A thin plastic film or passepartout 302 may be adhered on the back of the smart glass 301 to hide the edges of the artwork 303 and/or the mount hardware 305. Alternatively, the artwork 303 may be mounted directly on the back of the smart glass such that the artwork mounting frame 304 and the spacer 306 are not further required.

For all embodiments described above, a mirror may also be used instead of the artwork. An accessory tray, either small or the whole length of the board, may be included. A magnetism may be introduced on the transparent panel so that magnetic whiteboard accessories can be used. Common picture frame hanging system such as picture hanging hooks may be used to hang the whiteboard on the wall.

Alternatively, the whole whiteboard assembly may be mounted on the wall using hinged wall mount brackets, preferably on the left-hand or right-hand side of the whiteboard, such that the whiteboard can be rotated easily to mount or exchange the artwork. Passepartout may also be used not only to increase the artistic appearance but also to hide the pulling string and other support or mounting components.

All above embodiments are only used to illustrate the present invention, not intended to limit the scope thereof. Many modifications of the above embodiments can be made without departing from the spirit of the present invention.

1. A whiteboard comprising
a main frame assembly with a transparent panel or a frameless transparent panel;
an artwork assembly containing an artwork, a mounting foam board and a support frame;
a screen assembly consisting of a white or color screen connected with support strips or rods, hidden pulling strings, and a tube to hang and slide the screen; and
mounting components consisting of brackets with a hinge element to ease installation and brackets with a hook or a roller to hide the pulling strings, as well as locking elements to lock the whole assembly.

2. A whiteboard comprising the following two main sub-assemblies:
a main frame assembly with a transparent panel or a frameless transparent panel; and
a mounting frame assembly to mount all components of artwork and screen assemblies
including brackets with a hook or a roller to hide the pulling strings, as well as locking elements to lock the whole assembly.

3. The whiteboard as claimed in claim 2, wherein both sub-assemblies are assembled using mounting screw, pin, fitting tab, snap-fit, sliding lock, hinge, slot-fitting element, hanging element or magnet in order to ease the installation or change of the artwork.

4. The whiteboard as claimed in claim 2, wherein the mounting frame assembly is mounted on the wall, whereas the main frame assembly with the transparent panel is hung on it, or alternatively both sub-assemblies are hinged on one side so that the main frame with the transparent panel can be rotated to change the artwork.

5. The whiteboard as claimed in claim 1, wherein the tube is mounted so that it can rotate easily when the screen is pulled downwards in order to ease the screen pulling, by mounting the tube on pins or even with bearings.

6. The whiteboard as claimed in claim 2, wherein the tube is mounted so that it can rotate easily when the screen is pulled downwards in order to ease the screen pulling, by mounting the tube on pins or even with bearings.

7. The whiteboard as claimed in claim 1, wherein the screen is connected to or wound on a reel mounted on one side of the whiteboard,
wherein the reel may be spring loaded so that the screen can be automatically retracted, and
wherein the screen may be retracted and respectively extended in front of the artwork by means of a commercially available crank or chain mechanism or electric motor.

8. The whiteboard as claimed in claim 2, wherein the screen is connected to or wound on a reel mounted on one side of the whiteboard,
wherein the reel may be spring loaded so that the screen can be automatically retracted, and
wherein the screen may be retracted and respectively extended in front of the artwork by means of a commercially available crank or chain mechanism or electric motor.

9. The whiteboard as claimed in claim 1, wherein guiding elements or guiding design features at the end of the pulling rod and/or on the main frame sides are included so that the pulling rod and thus the screen can be pulled in parallel.

10. The whiteboard as claimed in claim 2, wherein guiding elements or guiding design features at the end of the pulling rod and/or on the main frame sides are included so that the pulling rod and thus the screen can be pulled in parallel.

11. The whiteboard as claimed in claim 1, wherein a magnetism is introduced on the transparent panel so that magnetic whiteboard accessories can be used.

12. The whiteboard as claimed in claim 2, wherein a magnetism is introduced on the transparent panel so that magnetic whiteboard accessories can be used.

13. The whiteboard as claimed in claim 1, wherein several different paintings, posters, or calendar of months are part of the screen in the form of a roll with one portion of it is white or in color so that the function as whiteboard or artwork is performed alternately.

14. The whiteboard as claimed in claim 2, wherein several different paintings, posters, or calendar of months are part of the screen in the form of a roll with one portion of it is white or in color so that the function as whiteboard or artwork is performed alternately.

15. The whiteboard as claimed in claim 1, wherein the artwork is illuminated from the front or from the back if the artwork is translucent.

16. The whiteboard as claimed in claim 2, wherein the artwork is illuminated from the front or from the back if the artwork is translucent.

17. The whiteboard as claimed in claim 1, wherein the artwork is displayed alternately on electronic devices such as a monitor.

18. The whiteboard as claimed in claim 2, wherein the artwork is displayed alternately on electronic devices such as a monitor.

19. The whiteboard as claimed in claim 1, wherein
the main frame is made from metal profile or common picture framing materials;
the mounting components are made from metals using common metal processing such
as casting or stamping that includes punching and bending; or the main frame and the mounting components are made from plastic materials using common polymer processing such as injection molding as one piece or as separate parts that are assembled with additional mounting components such as screw or assembled without mounting components using snap fit design features.

20. The whiteboard as claimed in claim 2, wherein
the main frame is made from metal profile or common picture framing materials; or
the main frame is made from plastic materials using common polymer processing such as injection molding as one piece or as separate parts that are assembled with additional mounting components such as screw or assembled without mounting components using snap fit design features; and
the mounting frame including the mounting components are made from metals using common metal processing such as casting or stamping that includes punching and bending; or the mounting frame including the mounting components are made from plastic materials using common polymer processing such as injection molding as one piece or as separate parts that are assembled with additional mounting components such as screw or or assembled without mounting components using snap fit design features.

21. A whiteboard comprising:
a main frame assembly with a transparent panel or a frameless transparent panel,
wherein a smart glass or a common glass laminated with a smart film is used as the transparent panel in order to achieve an opaque color background;
an artwork assembly containing an artwork, mounting or backing board and a support frame; and
mounting components.

22. The whiteboard as claimed in claim 21, wherein
the main frame is made from metal profile or common picture framing materials; or
the main frame is made from plastic materials using common polymer processing such as injection molding as one piece or as separate parts that are assembled with additional mounting components such as screw or assembled without mounting components using snap fit design features.
